(19) United States
(12) Patent Application Publication
(10) Pub. No.: US 2007/0154194 A1
(43) Pub. Date: Jul. 5, 2007

(54) Camera position sensing device and mobile phone having the same

(75) Inventors: Young Bok Yoon, Gyeonggi-do (KR); Ki Suk Woo, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/640,219

(22) Filed: Dec. 18, 2006

(30) Foreign Application Priority Data
Dec. 29, 2005 (KR) 10-2005-0133753

(51) Int. Cl. G03B 17/00

(52) U.S. Cl. 396/50

(57) ABSTRACT

A camera position sensing device comprises a magnet installed in a first member which has a camera module mounted therein, and a hall element installed in a second member which is relatively rotatably coupled to the first member, to sense a position of the camera module depending upon a position of the hall element relative to the magnet, wherein an initial offset is afforded to an installation position of the magnet in a relative rotating direction of the magnet.

### CROSS REFERENCE TO RELATED APPLICATION(S)

This application claims the benefit of Korean Patent Application No. 10-2005-0133753, filed Dec. 29, 2005, entitled “Device for sensing position of camera and mobile phone comprising the same”, which is hereby incorporated by reference in its entirety into this application.

### BACKGROUND OF THE INVENTION

1. Field of the Invention

The present invention relates, in general, to a camera position sensing device for a mobile communication terminal such as a mobile phone, and more particularly, to a camera position sensing device which is installed in a phone body and a hinge capable of being rotated relative to the phone body to sense the rotation angle of a camera, and to a mobile phone having the same.

2. Description of the Prior Art

As is generally known in the art, in a mobile communication terminal, a magnet is installed in a camera module, and a sensor (for example, a hall element) for sensing the density of magnetic flux generated in the magnet (for example, a change in a magnetic field) is installed in a terminal body. When the camera module is rotated relative to the terminal body, the rotation angle thereof can be sensed by the sensor.

That is to say, a camera position sensing device comprises a magnet which is installed in a relatively rotatable member and a hall element which is installed in a relatively fixed member. The rotated state of a camera is detected using the magnetic flux density of the magnet which is sensed by the hall element.

FIG. 1 is a front view illustrating a conventional mobile phone 10 having a camera position sensing device. The construction of the mobile phone 10 will be described with reference to FIG. 1.

The general structure of the mobile phone 10 having a camera module 50 includes a phone body 20 which has a key pad 22, and a folding part 30 which is coupled to the phone body 20 through a hinge 40 and has an LCD module 32. In FIG. 1, the camera module 50 is illustrated as being coupled to the hinge 40.

A sensor 24 such as a hall element is installed in the phone body 20, which is relatively fixed, and a magnet 34 is installed in a member (for example, the folding part 30 in FIG. 1) which is rotated relative to the phone body 20. The rotation angle of the camera module 50, that is, the rotation angle of the lens of the camera module 50, is sensed using the sensor 24 and the magnet 34. In FIG. 1, the rotation angle of the camera module 50 can be utilized, for example, to allow a display screen on the LCD module 32 of the folding part 30 to be reversed depending upon the rotated state of the camera module 50 (the direction of the camera lens).

FIGS. 2A through 2C illustrate a typical example in which the rotated state of a camera module 50 is sensed by a magnet 54 which is rotated about a hinge and the hall element (the sensor) 24 of a phone body 20 which is relatively fixed.

In FIG. 2A through 2C, the magnet 54 is directly attached to the camera module 50 such that the magnet 54 can be rotated together with the camera module 50 about the hinge with respect to the relatively fixed phone body 20.

Referring to FIG. 2A, when the lens 52 of the camera module 50 faces forward (in the direction indicated by the arrow A), the magnet 54 is positioned farthest from the sensor 24 of the phone body 20. The magnet 54 is arranged on a reference line C which connects the rotation center of the camera module 50 (that is, the center axis of the hinge) with the sensor 24, and at this time, the angle between the magnet 54 and the sensor 24 is determined as θ1. Actually, the angle θ1 is defined perpendicularly to the direction of the arrow A.

Next, FIG. 2B illustrates the state in which the camera module 50 is rotated by a quarter turn, that is, 90°, so that the lens 52 faces away from the phone body 20. At this time, the magnet 54 is positioned perpendicular to the reference line C, and the angle between the magnet 54 and the sensor 24 is determined to be θ2.

Finally, FIG. 2C illustrates the state in which the camera module 50 is rotated by a half turn, that is, 180°, so that the lens 52 faces rearward (in the direction indicated by the arrow B). At this time, the magnet 54 is positioned nearest to the sensor 24 of the phone body 20, and the angle between the magnet 54 and the sensor 24 is determined to be θ3.

As can be readily seen from the above descriptions, in the camera position sensing structure as shown in FIGS. 2A through 2C, with the rotation of the camera module 50, as the magnet 54 is rotated from the farthest position toward the nearest position with respect to the sensor 24, the rotation angle of the camera module 50 is sensed in conformity with a change in the position of the camera module 50.

However, in the structure for sensing the rotation of the camera module 50 using the magnet 54 and a sensor 24 such as a hall element, since the rotated state of the camera module 50 is sensed using only the relative distance between the magnet 54 and the sensor 24, erroneous operation of the mobile phone may result.

For example, referring to FIG. 3, assuming that the angle at the forward facing position (the direction indicated by the arrow A in FIG. 2A) is 0° and that the angle at the rearward facing position (the direction indicated by the arrow B in FIG. 2C) is 180°, by analyzing the measurement results obtained from the sensor 24 while the camera module 50 is rotated from 0° to 180°, it was confirmed that the sensor 24 doubly passes through an optional operation point (for example, the point having a magnetic flux density of 40 gauss).

In other words, in the case of the mobile phone having the conventional camera position sensing structure, when the folding part is fully rotated from 0° to 180°, the sensor 24 passes an optional operation point twice, and therefore, it is difficult to precisely sense the rotated state of the camera module 50.

Of course, this phenomenon can be prevented by limiting the rotation angle of the folding part to an angle (for example, about 135°) which is immediately before the camera module 50 secondarily passes through the optional operation point, but in this case, the design of the mobile phone cannot but be negatively impacted.

### SUMMARY OF THE INVENTION

Accordingly, the present invention has been made keeping in mind the above problems occurring in the prior art, and an object of the present invention is to provide a camera position sensing device which employs a magnet and a sensor to sense the rotated state of a camera module so that a linear sensing result is obtained from the sensor throughout the entire rotation range of the camera module.

Another object of the present invention is to provide a mobile phone which has a camera position sensing device capable of linearly sensing the position of a camera.

In order to achieve the first object, according to one aspect of the present invention, there is provided a camera position sensing device comprising a magnet installed in a first member which is mounted with a camera module; and a hall element installed in a second member which is relatively rotatably coupled to the first member, to sense the position of the camera module depending upon the relative position of the hall element with respect to the magnet, wherein an initial offset is afforded to an installation position of the magnet in the relative rotating direction of the magnet.

According to another aspect of the present invention, the hall element senses the position of the camera module based on the relative position of the hall element from the magnet and the direction of the magnetic flux of the magnet.

According to another aspect of the present invention, as the initial offset is afforded to the magnet, the hall element linearly senses the position of the camera module.

According to another aspect of the present invention, the camera module is rotatably mounted to the first member, and the magnet is directly installed on the camera module.

According to another aspect of the present invention, the camera module includes a lens, and the position of the camera module indicates the orientation of the lens.

In order to achieve the second object, according to another aspect of the present invention, there is provided a mobile phone having a camera position sensing device, comprising a first member having a camera module mounted thereon; a second member relatively rotatably coupled to the first member; and a camera position sensing device having a magnet which is installed in one of the first and second members and a hall element which is installed in the other of the first and second members, wherein the hall element senses the position of the camera module depending upon the relative position of the hall element with respect to the magnet, and an initial offset is afforded to an installation position of the magnet in the relative rotating direction of the magnet.

According to another aspect of the present invention, the second member comprises a phone body which has a key pad, and the first member comprises a hinge shaft which is rotatably coupled to one side of the phone body.

According to another aspect of the present invention, the mobile phone further comprises a folding part connected to the phone body by the medium of the hinge shaft and attached with an LCD module.

According to still another aspect of the present invention, as the initial offset is afforded to the magnet, the hall element linearly senses the position of the camera module.

According to a still further aspect of the present invention, the camera module is rotatably mounted to the first member, and the magnet is directly installed on the camera module.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a front view illustrating a conventional mobile phone having a camera position sensing device;

FIGS. 2A through 2C are diagrammatic views illustrating the operation of a conventional camera position sensing device;

FIG. 3 is a graph illustrating the measurement results of the camera position sensing device of FIG. 2 depending upon rotation angles;

FIGS. 4A through 4C are diagrammatic views illustrating the operation of a camera position sensing device in accordance with an embodiment of the present invention;

FIG. 5 is a graph illustrating the measurement results of the camera position sensing device of FIG. 4 depending upon rotation angles; and

FIG. 6 is a perspective view illustrating a mobile phone in accordance with another embodiment of the present invention.

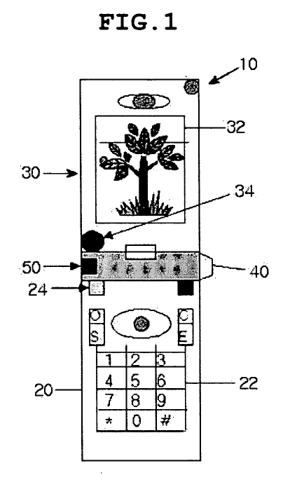

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

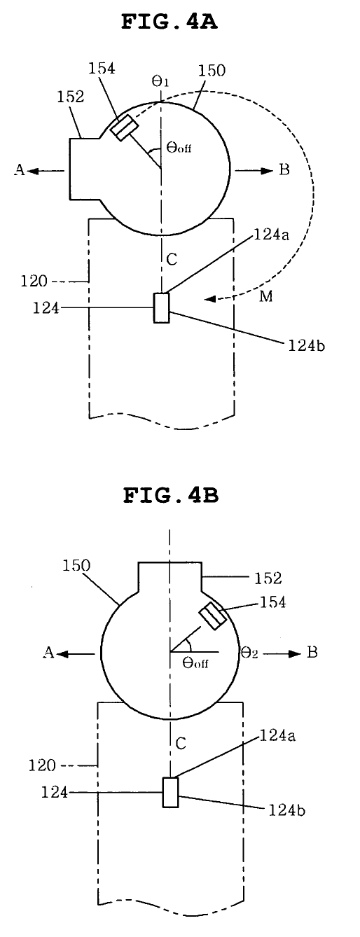

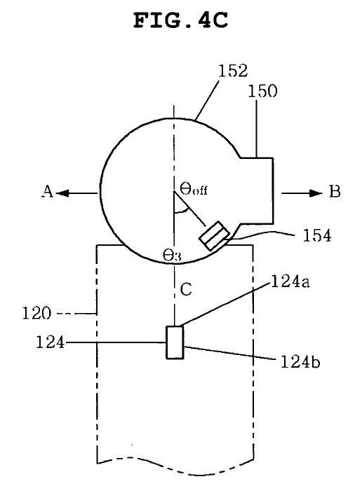

FIGS. 4A through 4C are diagrammatic views illustrating the constructions and operations of a magnet and a hall element in accordance with an embodiment of the present invention.

Referring to FIG. 4A, a camera position sensing device in accordance with the embodiment of the present invention comprises the pair of a magnet 154 attached to a camera module 150 and a sensor 124 such as a hall element attached to a phone body 120. According to the present invention, the magnet 154 has a predetermined initial offset angle θ_{off} in the rotating direction of a camera, which is measured from a reference line C connecting the center of the camera module 150 (for example, the rotation axis of a hinge) with the sensor 124.

Concretely speaking, referring to FIG. 4A, when the lens 152 of the camera module 150 faces forward (in the direction indicated by the arrow A), as the magnet 154 is initially offset by the angle θ_{off} in the direction opposite the rotating direction of the camera module 150, the initial offset angle θ_{off} is afforded. That is to say, when the lens 152 of the camera module 150 faces forward (in the direction indicated by the arrow A), the magnet 154 is initially offset from the conventional position θ1 in the direction opposite the rotating direction of the camera module 150 by an angle corresponding to the initial offset θoff.

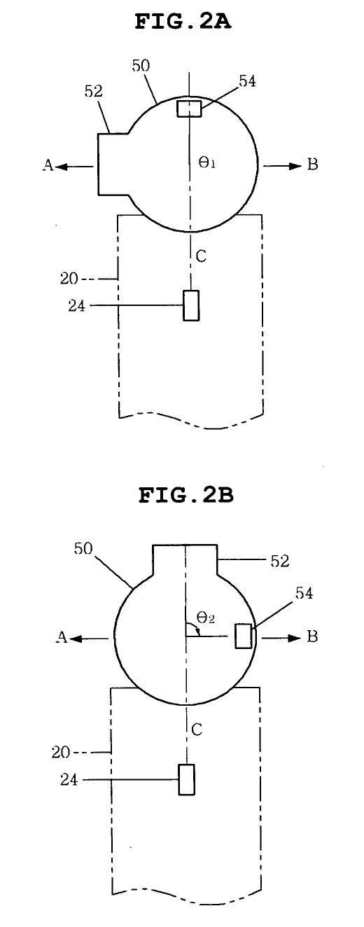

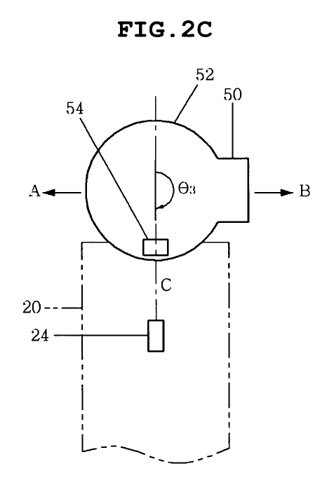

Referring to FIGS. 4B and 4C, as the camera module 150 is rotated with the initial offset θ_{off} afforded, when compared to the conventional positions θ2 and θ3 (see FIGS. 2B and 2C), the magnet 154 is rotated while it is offset by the initial offset angle θ_{off} In other words, when the lens 152 of the camera module 150 faces away from the phone body 120 and faces rearward (in the direction indicated by the arrow B), when compared to the conventional positions θ2 and θ3, the magnet 154 is rotated while maintaining the initial offset θ_{off}.

By affording the initial offset θ_{off} to the installation position of the magnet 154, the hall element 124 can precisely sense a change in a magnetic field which is generated in the magnet 154.

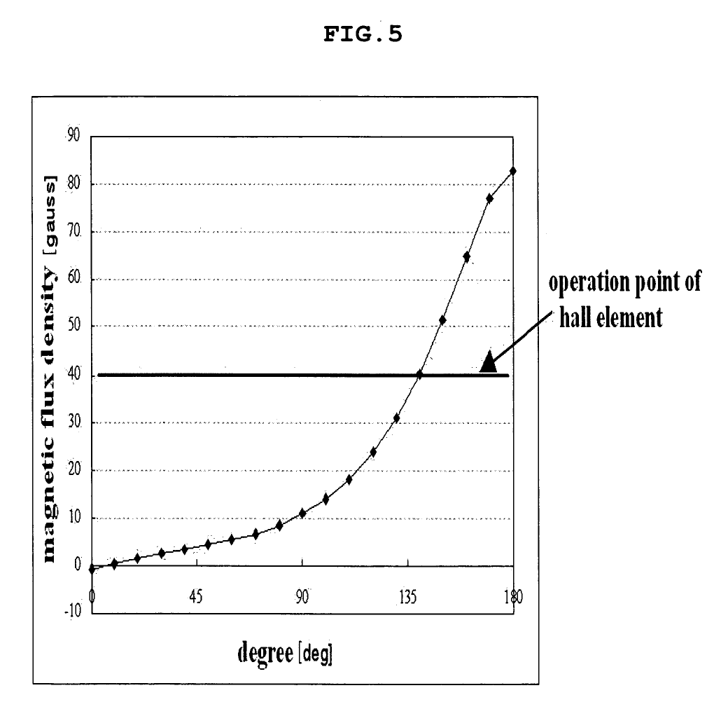

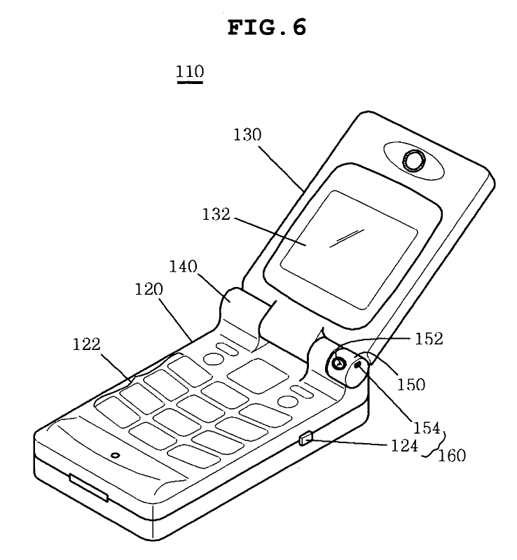

In the conventional art, since the magnet is simply positioned based on the relative distance between the magnet and the hall element, the sensor doubly passes through an operation point. However, in the camera position sensing device according to the present invention, the magnetic flux density is linearly sensed, as shown in FIG. 5. That is to say, while the folding part is rotated from 0° to 180°, the rotated state of the camera depending upon the magnetic flux density of the magnet is linearly detected, whereby the rotated state of the folding part can be precisely sensed.

This is based on the fact that the portion of the magnet for sensing the magnetic flux density is not the portion 124a of the hall element 124 which faces the hinge but the portion 124b of the hall element 124 which is perpendicular to the reference line C. That is to say, in order to measure the density of the magnetic flux generated in the magnet, a magnetic field M must perpendicularly pass through the portion of the hall element 124. To this end, as can be readily seen from FIG. 4A, the magnetic flux density is detected from the portion 124b of the hall element 124 which is perpendicular to the reference line C.

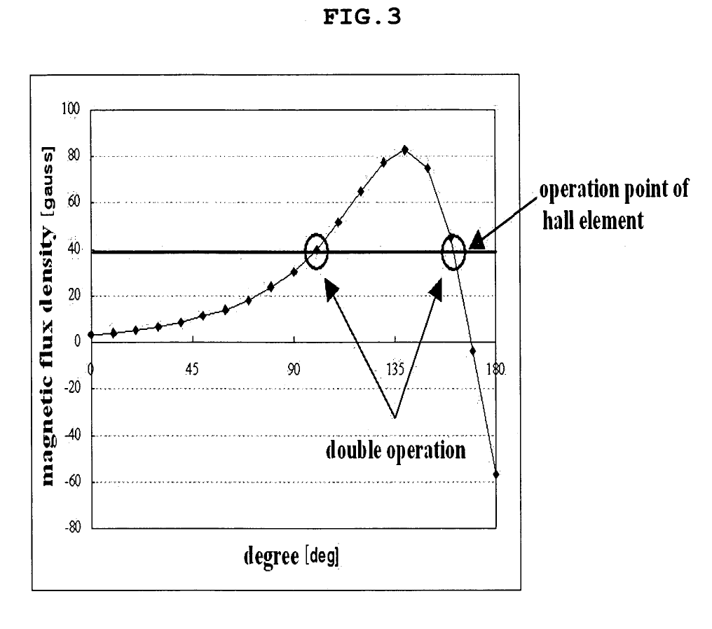

For reference, each of FIGS. 3 and 5 illustrates an analyzing graph which is obtained by programming the relative positional relationship between the magnet and the hall element in each of the conventional art and the present invention, and calculating sensing results using a technique such as a finite element method (FEM). Concretely speaking, each of FIGS. 3 and 5 illustrates magnetic flux densities which are sensed while rotating the lens of the camera module from 0° (in the example, the direction indicated by the arrow A) to 180° (in the example, the direction indicated by the arrow B).

As a consequence, in the camera position sensing device according to the embodiment of the present invention, as the magnet is offset by the initial offset angle θ_{off}, the magnetic flux densities of the magnet, which are sensed by the hall element, are linearly obtained, and thus, it is possible to prevent misoperation of the mobile phone which is otherwise caused in the conventional art due to double passage through an operation point. Also, in the present invention, since the linear sensing results can be obtained by affording the initial offset, it is possible to reverse a display screen by setting an optional operation point as desired.

In the conventional art, in order to prevent such misoperation, a specific operation point having a predetermined value (for example, 40 gauss) must be set. However, in the present invention, since the magnetic flux density is linearly measured, even when an optional operation point is set, the misoperation is not caused. Consequently, it is possible to freely set an operation point to conform with a desired rotation angle (a desired rotation angle of the camera module) when designing the mobile phone.

FIG. 6 is a perspective view illustrating a mobile phone 110 in accordance with another embodiment of the present invention. The construction of the mobile phone 110 according to this embodiment of the present invention will be described with reference to FIG. 6.

The mobile phone 110 according to this embodiment of the present invention includes a phone body 120 which has a key pad 122, a folding part 130 which is rotatably coupled to the phone body 120 through a hinge 140 and has an LCD module 132, and a camera module 150 which is provided adjacent to an end of the hinge 140 and can be rotated with respect to the phone body 120 irrespective of the hinge 140. A magnet 154 is installed on one side of the camera module 150 at an initial offset angle θ_{off}, and a hall element 124 capable of sensing the magnetic flux density of the magnet 154 is installed on a side of the phone body 120.

The pair of the magnet 154 of the camera module 150 and the hall element 124 of the phone body 120 constitutes a camera position sensing device 160 according to the present invention.

The mobile phone according to the present invention has the camera position sensing device which comprises the magnet and the hall element. In the mobile phone, by using the camera position sensing device, the position of the camera can be linearly sensed in conformity with the rotated state of the camera (between the forward direction indicated by the arrow A and the rearward direction indicated by the arrow B), and the sensing result can be reflected on the LCD module of the folding part. That is to say, the image displayed on the LCD module can be reversed as the occasion demands depending upon the rotated state of the camera module (the lens of the camera module).

While it was explained with reference to FIG. 6 that the magnet and the hall element were respectively installed in the camera module disposed in the hinge and the phone body, the present invention is not limited to this arrangement. Namely, while not shown in a separate drawing, it can be envisaged that a camera module is disposed in a folding part which has an LCD module, and a magnet which is afforded with an initial offset θ_{off} according to the feature of the present invention is installed in the folding part.

As is apparent from the above description, the camera position sensing device according to the present invention comprises the pair of a hall element and a magnet. Specifically, due to the fact that the position of the magnet has an initial offset angle θ_{off} in the rotating direction, the magnetic flux density of the magnet can be linearly sensed within the rotation range (from 0° to 180°) of a camera. By using the camera position sensing device, the problem of the rotated state of the camera being erroneously sensed due to the misoperation of the camera position sensing device can be solved.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A camera position sensing device, comprising:
a magnet installed in a first member which has a camera module mounted therein; and
a hall element installed in a second member which is relatively rotatably coupled to the first member, to sense a position of the camera module depending upon a relative position of the hall element from the magnet,
wherein an initial offset is afforded to an installation position of the magnet in a relative rotating direction of the magnet.

2. The device as set forth in claim 1, wherein the hall element senses the position of the camera module based on the relative position of the hall element with respect to the magnet and a direction of the magnetic flux of the magnet.

3. The device as set forth in claim 1, wherein, as the initial offset is afforded to the magnet, the hall element linearly senses the position of the camera module.

4. The device as set forth in claim 1, wherein the camera module is rotatably mounted to the first member, and the magnet is directly installed on the camera module.

5. The device as set forth in claim 1, wherein the camera module includes a lens, and the position of the camera module indicates a direction of the lens.

6. A mobile phone having a camera position sensing device, comprising:
a first member mounted with a camera module;
a second member relatively rotatably coupled to the first member; and
a camera position sensing device having a magnet which is installed in one of the first and second members and a hall element which is installed in the other of the first and second members,
wherein the hall element senses a position of the camera module depending upon a position of the hall element relative to the magnet, and an initial offset is applied to an installation position of the magnet in a relative rotating direction of the magnet.

7. The mobile phone as set forth in claim 6, wherein the second member comprises a phone body which has a key pad, and the first member comprises a hinge shaft which is rotatably coupled to a side of the phone body.

8. The mobile phone as set forth in claim 7, further comprising:
a folding part, connected to the phone body by the hinge shaft, and having an LCD module attached thereto.

9. The mobile phone as set forth in claim 6, wherein, as the initial offset is afforded to the magnet, the hall element linearly senses the position of the camera module.

10. The mobile phone as set forth in claim 6, wherein the camera module is rotatably mounted to the first member, and the magnet is directly installed on the camera module.
